(19) United States
(12) Patent Application Publication
(10) Pub. No.: US 2025/0044221 A1
(43) Pub. Date: Feb. 6, 2025

(54) ARRANGEMENT AND METHOD FOR MEASURING A CONCENTRATION OF REPROCESSING AGENTS IN A REPROCESSING LIQUID

(71) Applicant: Olympus Winter & Ibe GmbH, Hamburg (DE)

(72) Inventors: Alexander Werner, Bielefeld (DE); Martin Schnieders, Bielefeld (DE); Celina Werner, Bochum (DE); Gregor Goldberg, Warendorf (DE)

(73) Assignee: Olympus Winter & Ibe GmbH, Hamburg (DE)

(21) Appl. No.: 18/792,837

(22) Filed: Aug. 2, 2024

Related U.S. Application Data
(60) Provisional application No. 63/530,496, filed on Aug. 3, 2023.

(51) Int. Cl. G01N 21/27

(52) U.S. Cl. CPC G01N 21/27

(57) ABSTRACT

An apparatus for measuring a concentration of reprocessing agents in a reprocessing liquid used in a reprocessing apparatus for medical instruments. The apparatus comprising: a measuring system; a first conduit for a hydraulic connection of the measuring system with a reprocessing circuit of the reprocessing apparatus; and a second conduit for a bypass connection of the measuring system into a reprocessing chamber of the reprocessing apparatus. The measuring system is configured to: receive a test strip with a test surface and to position the test strip in a first, dosing position and a second, measuring position; dose a predetermined amount of reprocessing liquid onto the test surface when the test strip is positioned in the first, dosing position; and measure the concentration of reprocessing agents in the reprocessing liquid when the test strip is positioned in the second, measuring position by evaluating the test surface, via an evaluating sensor.

### CROSS-REFERENCE TO RELATED APPLICATION

The present application is based upon and claims the benefit of priority from U.S. Provisional Application No. 63/530,496 filed on Aug. 3, 2023, the entire contents of which is incorporated herein by reference.

The present application is related to the following co-pending U.S. Applications, each filed on Aug. 2, 2024, U.S. patent application Ser. No. 18/xxx,xxx (corresponding to U.S. Provisional Patent Application 63/530,490); U.S. patent application Ser. No. 18/xxx,xxx (corresponding to U.S. Provisional Patent Application 63/530,492); U.S. patent application Ser. No. 18/xxx,xxx (corresponding to U.S. Provisional Patent Application 63/530,500); and U.S. patent application Ser. No. 18/xxx,xxx (corresponding to U.S. Provisional Patent Application 63/530,504); the entire contents of each of which is incorporated herein by reference.

### BACKGROUND

### Field

The present disclosure relates to an arrangement for measuring a concentration of reprocessing agents in a reprocessing liquid used in a reprocessing apparatus for medical instruments, a reprocessing apparatus for medical instruments, a method for measuring a concentration of reprocessing agents in a reprocessing liquid used in a reprocessing apparatus for medical instruments, and a method for reprocessing medical instruments.

### Prior Art

Arrangements for measuring a concentration of reprocessing agents in a reprocessing liquid are often used in or as analysis units for detecting cleaning, sterilization and/or disinfection agents. Such analysis units may be used, for example, in water-bearing household appliances are known, for example, from DE 102009027950 A1. This document relates to a household device having a control device for performing rinse cycles, which are adjusted by the control device using cleaning agents e.g. additives. An analyzing unit detects the cleaning agents and is provided with a reading unit for radio frequency identification of barcode or other identification marks printed on the cleaning agents. The analyzing unit is connected with the control device for transmitting analyzing data from the analyzing unit to the control unit.

Furthermore, EP 3302210 B1 discloses a device and a method for determining the composition of the dirt load in a rinsing or detergent solution in a water-using household appliance, for example in a dishwasher, using near infrared spectroscopy (NIR).

Patent application DE 19806559 B4 discloses a method involving emitting rays into a dish stack, determining and/or recording a quantity or rays of at least one wavelength range, leaving the stack under respectively one predetermined angle, assuming a kind and a concentration of a pollution ratio and/or a cleaner ratio of the dish stack, and optimizing a dish washer program, accordingly. A corresponding dish washer arrangement is also disclosed.

Patent application DE 102007011119 A1 relates to a washing machine with an automatic controller for washing process and optical sensor devices. The optical sensor devices transmit signals, which are evaluated for controlling the washing process. The optical sensor devices detect light intensities of different spectral regions. The optical sensor devices are sensitive over the entire spectral region from infrared to ultraviolet. The optical sensor devices are arranged at a bypass such that the optical sensor devices measure characteristics of detergent components in different positions.

Existing solutions for measuring a concentration of reprocessing agents in a reprocessing liquid, however, usually are comparatively expensive and often require the use of specialized chemicals. Further, existing solutions are often operated fully or partly manually and/or are not always accurate and robust against operating errors. For Example, existing solutions for measuring a concentration of reprocessing agents in a reprocessing liquid are often not suitable, reliable or accurate enough for specific areas of application.

### SUMMARY

Therefore, an object is to provide a solution, which reduces or eliminates one or more of the above-mentioned disadvantages. For example, an object is to provide an improved arrangement for measuring a concentration of reprocessing agents in a reprocessing liquid used in a reprocessing apparatus for medical instruments and an improved method for measuring a concentration of reprocessing agents in a reprocessing liquid used in a reprocessing apparatus for medical instruments, which are reliable, accurate, cost-efficient, and less sensitive to operation errors.

According to an embodiment, an arrangement (apparatus) is provided for measuring a concentration of reprocessing agents in a reprocessing liquid used in a reprocessing apparatus for medical instruments, comprising a measuring system; a first conduit for a hydraulic connection of the measuring system with a reprocessing circuit of the reprocessing apparatus, such as with the circulation pump of the reprocessing apparatus; and a second conduit for a bypass connection of the measuring system back into a reprocessing chamber of the reprocessing apparatus; wherein the measuring system is configured to receive a test strip with a test surface and to position the test strip in a first, dosing position and a second, measuring position; wherein the measuring system is adapted to dose a predetermined amount of reprocessing liquid onto the test surface when the test strip is positioned in the first, dosing position; wherein the measuring system is adapted to measure the concentration of reprocessing agents in the reprocessing liquid when the test strip is positioned in the second, measuring position by evaluating the test surface, such as via an evaluating unit.

In the following, initially the arrangement for measuring a concentration of reprocessing agents in a reprocessing liquid used in a reprocessing apparatus for medical instruments and its components, functions and advantageous embodiments will be described.

Reprocessing as used herein may comprise all steps necessary to reuse previously used medical instruments, including removing blood, tissue and other biological debris and inactivating infectious microorganisms and/or viruses. For example, reprocessing may encompass, but is not limited to, initial basic and subsequent thorough cleaning, and/or disinfecting, and/or sterilizing the medical instruments using suitable cleaning, and/or disinfecting, and/or sterilizing agents. Reprocessing may also encompass re-packaging and of terminally sterilizing the previously cleaned, and/or disinfected, and/or sterilized medical instruments. Reprocessing agents may comprise reprocessing chemicals, for example peracetic acids. A reprocessing cycle may encompass a procedure, carried out, for example, in a reprocessing apparatus, used to reprocess a medical instrument between two uses. A reprocessing cycle may encompass a process of cleaning and/or rinsing and/or disinfection and/or sterilization.

Medical instruments as used herein can encompass endoscopes and/or probes, for example, and further specified medical instruments that may be reusable, such as reusable endoscopes and/or reusable probes.

The reprocessing of medical instruments is particularly sensitive for the safety of medical procedures using such medical instruments and thus highest requirements for the reliability of such reprocessing apply. For example, the requirements in reprocessing medical instruments differ from and exceed those for water-bearing household appliances, such as dishwashers and washing machines, by far and significantly. Therefore, solutions for such water-bearing household appliances are not suitable or sufficient for the requirements applying to the reprocessing of medical instruments between different medical procedures on different patients.

The arrangement can comprise a measuring system which is configured to position a test strip in at least a first, dosing position and, can subsequently, position the test strip in a second, measuring position. The first and second positions differ from each other, such as in relation to a reprocessing liquid feed system and/or a sample feed line and/or the evaluation unit. In order to position the test strip in the first and second positions, the test strip can be moved or the reprocessing liquid feed system and/or the sample feed line and/or the evaluation unit can be moved. Further the test strip and the reprocessing liquid feed system and/or the sample feed line and/or the evaluation unit can be moved.

By providing the first and second conduits, a kind of bypass liquid connection or bypass circuit is provided, along which the measuring system is positioned. This may allow, for example, to position the measuring system or parts thereof outside of a housing of a reprocessing apparatus or at its outer periphery. Further, the measuring system or parts thereof may have an interface on an outer periphery of a reprocessing apparatus. In this way, the measuring system can be physically decoupled—but still in liquid connection to—reprocessing circuits needed for the actual reprocessing of the instruments. This can have the advantage that a wider range of measuring systems may be used, for example ones that need an interaction with a user or components located outside of a reprocessing apparatus during reprocessing.

A further advantage can be that the provided arrangement can be adapted to be used with test strips, for example, such that the measuring system can evaluate a test surface of a test strip, which has been exposed to a dose of the reprocessing liquid, for which the concentration of reprocessing agent is to be measured.

This can be advantageous in combination with the positioning of the measuring system in a bypass circuit described above, since this allows for the measuring system to be positioned in an arrangement for measuring a concentration of reprocessing agents in a reprocessing liquid and/or in a reprocessing apparatus such that test strips can be exposed to a dose of reprocessing liquid in a first, dosing position and the test surface can be evaluated in a second, measuring position. For example, the arrangement can allow for a positioning of the measuring system which provides the space for a supply of test strips to be provided and can also be discarded after use. In this way, an easy and reliable solution to monitor the presence of a correct and/or prescribed concentration of reprocessing agents in a reprocessing liquid used in a reprocessing apparatus for medical instruments can be provided. The arrangement and measuring system can be configured to carry out measurements of the concentration of reprocessing agents in a reprocessing liquid used in a reprocessing apparatus for medical instruments two or several times during a reprocessing cycle.

In a further embodiment, the evaluating unit can comprise an optical spectrometer and/or an RGB color sensor. These evaluating units can be reliable and cost-effective.

The evaluating unit can be configured to compare an evaluation result with a reference value. The reference value can serve to ensure a concentration of reprocessing agents that is suitable and required in reprocessing of medical instruments achieves the required reprocessing result.

In a further embodiment, the measuring system can be configured to measure the concentration of reprocessing agents in the reprocessing liquid when the test strip is positioned in the second, measuring position by determining a characteristic, such as a color characteristic, of the test surface, and can compare the determined characteristic with a reference characteristic. This can allow for a cost-efficient and reliable method of measuring the concentration of reprocessing agents. Instead of directly analyzing the reprocessing liquid, an amount of reprocessing liquid can be allowed to act on the test surface of a test strip and then evaluate the test surface, such as a characteristic thereof. For example, test strips may be used which have a test surface that changes its color depending on the concentration of reprocessing agents in the liquid to which the test surface is exposed. Such a color change can be easily and reliably detected by an evaluation unit.

According to a further embodiment, the measuring system can be configured to let the predetermined amount of reprocessing liquid act on the test surface for a predetermined exposure time before evaluating the test surface. This embodiment can have the advantage of enhancing reliability of the measurement results.

The predetermined exposure time can be at least 3 seconds, at least 5 seconds, at least 10 seconds, at least 15 seconds, at least 20 seconds, at least 25 seconds, or at least 30 seconds. Further, the predetermined exposure time can be a maximum of 3 seconds, a maximum of 5 seconds, a maximum of 10 seconds, a maximum of 15 seconds, a maximum of 20 seconds, a maximum of 25 seconds, or a maximum of 30 seconds.

The arrangement can comprise a test strip guide, wherein the first, dosing position and the second, measuring position can be located along the test strip guide. The handling of test strips, such as during dosing and measuring, can be partly or fully automated. The movement of the test strip to and from the first, dosing position and the second, measuring position can be partly or fully automated. The provision of a test strip guide can be advantageous for automated handling and/or movement.

The measuring system can be configured to release the test strip after evaluating the test surface. As described above, a supply and discharge of the test strips can be provided for. The release of the test strips can be carried out in a discharge area. Further, the release and/or supply of test strips to the measuring system and/or the transport of test strips can be partly or fully automated.

In a further embodiment, the measuring system can be configured to dose the predetermined amount of reprocessing liquid onto the test surface when the test strip is positioned in the first, dosing position via a reprocessing liquid feed system and a sample feed line connected thereto. The reprocessing liquid feed system and/or the sample feed line can be in liquid connection to the bypass circuit and/or a branch thereof. The sample feed line can be a part of the reprocessing liquid feed system. The reprocessing liquid feed system can be fed with reprocessing liquid from the first conduit for a hydraulic connection of the measuring system with a reprocessing circuit of the reprocessing apparatus. The reprocessing liquid feed system can have the advantage of enhancing the accuracy of the dosing onto the test surface and thus can enhance the accuracy and reliability of the measurement.

According to a further embodiment, a reprocessing apparatus for medical instruments is provided, the reprocessing apparatus comprising a reprocessing chamber; a reprocessing circuit; and an arrangement for measuring a concentration of reprocessing agents in a reprocessing liquid as described herein.

According to a further embodiment, a method for measuring a concentration of reprocessing agents in a reprocessing liquid used in a reprocessing apparatus for medical instruments is provided, the method comprising positioning a test strip with a test surface in a first, dosing position; dosing a predetermined amount of reprocessing liquid onto the test surface when the test strip is positioned in the first, dosing position; positioning the test strip in a second, measuring position and evaluating the test surface to measure the concentration of reprocessing agents in the reprocessing liquid.

The method for measuring a concentration of reprocessing agents in a reprocessing liquid may further comprise measuring the concentration of reprocessing agents in the reprocessing liquid when the test strip is positioned in the second, measuring position by using an evaluating unit, such as an optical spectrometer and/or an RGB color sensor.

Further, the method for measuring a concentration of reprocessing agents in a reprocessing liquid may comprise measuring the concentration of reprocessing agents in the reprocessing liquid when the test strip is positioned in the second, measuring position by determining a characteristic, such as a color characteristic, of the test surface.

The method for measuring a concentration of reprocessing agents in a reprocessing liquid can further comprise providing a hydraulic connection of the measuring system with a reprocessing circuit of the reprocessing apparatus, such as with the circulation pump of the reprocessing apparatus, such as via a first conduit.

A further method step can be providing a bypass connection of the measuring system back into a reprocessing chamber of the reprocessing apparatus, such as via a second conduit.

Further, the method for measuring a concentration of reprocessing agents in a reprocessing liquid may comprise letting the predetermined amount of reprocessing liquid act on the test surface for a predetermined exposure time before evaluating the test surface.

The method for measuring a concentration of reprocessing agents in a reprocessing liquid can further comprise dosing the predetermined amount of reprocessing liquid onto the test surface when the test strip is positioned in the first, dosing position via a reprocessing liquid feed system and a sample feed line connected thereto.

Further, the method for measuring a concentration of reprocessing agents in a reprocessing liquid may comprise releasing the test strip after evaluating the test surface.

According to a further embodiment, a method for reprocessing medical instruments is provided, the method comprising providing at least one medical instrument in a reprocessing chamber and circulating reprocessing fluid in a reprocessing circuit, such as in a reprocessing apparatus for medical instruments as described herein; and further comprising the steps of the method for measuring a concentration of reprocessing agents in a reprocessing liquid used in a reprocessing apparatus for medical instruments as described herein.

As to the advantages, embodiments and details of the individual different aspects and their embodiments, reference is also made to the corresponding advantages, embodiments and details described with reference to the respective other aspects.

Further embodiments result from the combination of individual, several or all of the features described herein.

### BRIEF DESCRIPTION OF THE DRAWINGS

The embodiments shall now be described with reference to the attached drawings, in which

FIG. 1 illustrates a schematic depiction of an exemplary prior art reprocessing apparatus for medical instruments;

FIG. 2 illustrates a schematic depiction of an exemplary embodiment of a reprocessing apparatus for medical instruments;

FIG. 3 illustrates a schematic depiction of an arrangement for measuring a concentration of reprocessing agents in a reprocessing liquid used in the reprocessing apparatus for medical instruments of FIG. 2 in more detail;

FIG. 4 illustrates a schematic flow diagram of a method for measuring a concentration of reprocessing agents in a reprocessing liquid used in a reprocessing apparatus for medical instruments;

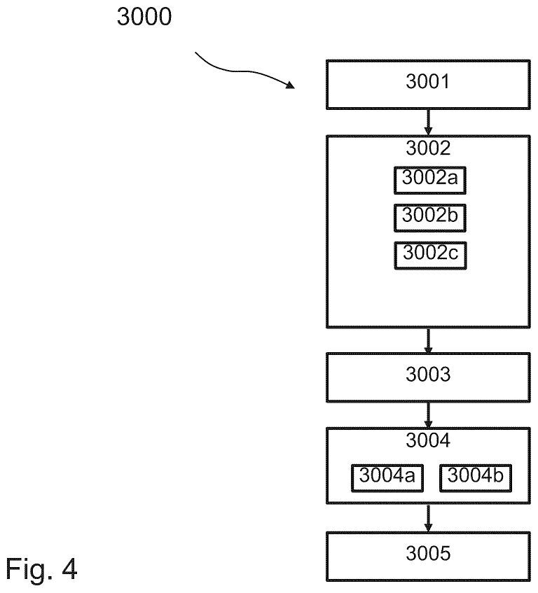

FIG. 5 illustrates a schematic flow diagram of a method for reprocessing medical instruments.

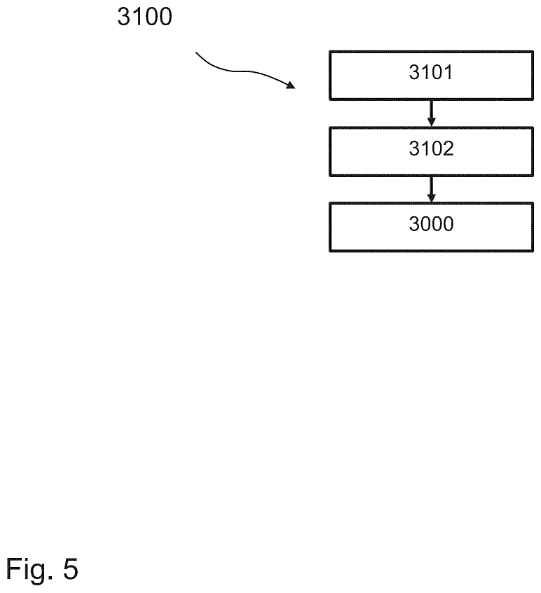

### DETAILED DESCRIPTION

In the figures, elements with the same or comparable functions are indicated with the same reference numerals.

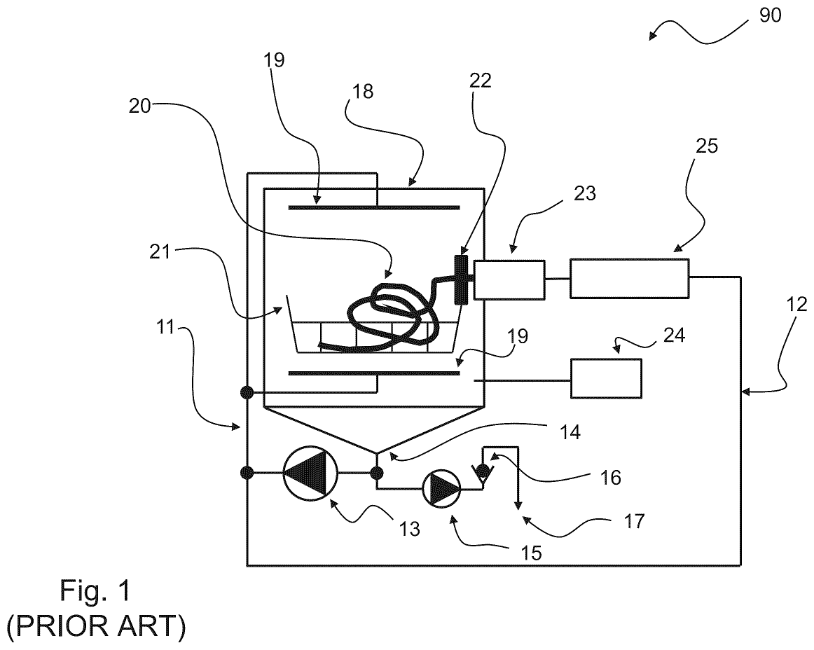

FIG. 1 shows a schematic layout of an exemplary prior art reprocessing apparatus 90 for medical instruments 20, for example endoscopes. The apparatus 90 may comprise a reprocessing chamber 18, in which a loading carrier 21 containing medical instruments 20 to be cleaned and/or disinfected and/or sterilized may be placed. Reprocessing liquid may be circulated in the apparatus 90 via circulation pump 13 and pump sump 14 in an outer reprocessing circuit 11 and an inner reprocessing circuit 12. The outer reprocessing circuit 11 may circulate the reprocessing liquid in the processing chamber 18 via at least one, such as two spray arms 19, as shown in FIG. 1. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17. The monitoring unit can be a “flow control,” which can be a dedicated module that monitors for blockages and dropped adapters. Such monitoring can operate by analyzing pressure differences. The values of which can be communicated via a so-called type list. The monitoring unit therefore also includes sensors, such as pressure sensors.

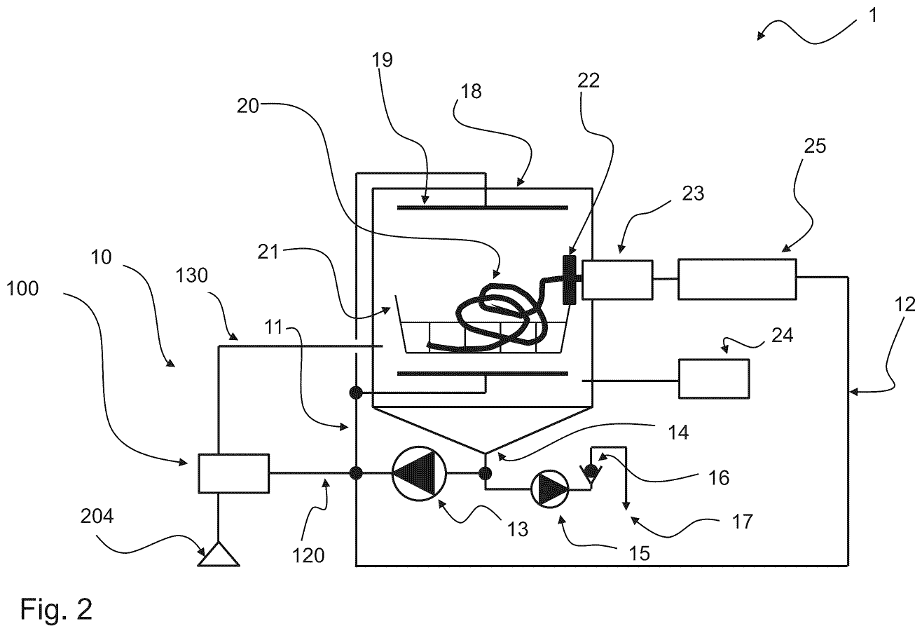

FIG. 2 shows a schematic layout of an exemplary embodiment of a reprocessing apparatus 1 for medical instruments 20, for example endoscopes. Also reprocessing apparatus 1 may comprise a reprocessing chamber 18, in which a loading carrier 21 containing medical instruments 20 to be cleaned and/or disinfected and/or sterilized may be placed. Reprocessing liquid may be circulated in the reprocessing apparatus 1 via circulation pump 13 and pump sump 14 in an outer reprocessing circuit 11 and an inner reprocessing circuit 12. The outer reprocessing circuit 11 may circulate the reprocessing liquid in the processing chamber 18 via least one, such as two spray arms 19. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The reprocessing apparatus 1 differs from existing reprocessing apparatus 90 such as in an arrangement (apparatus) 10 for measuring a concentration of reprocessing agents in a reprocessing liquid and a compressed air supply 204.

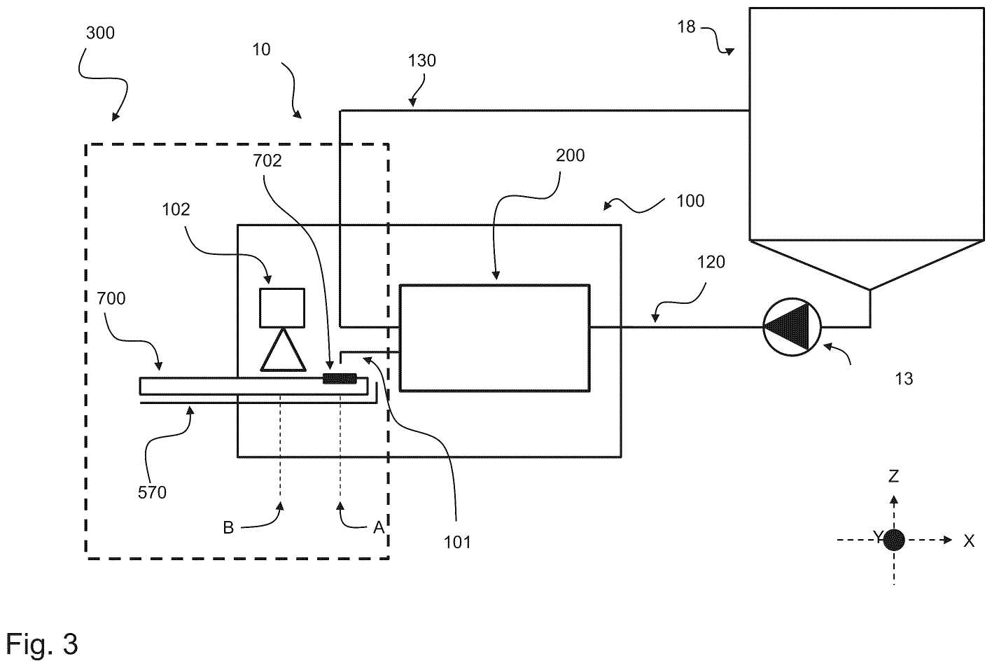

FIG. 3 shows a schematic depiction of an arrangement 10 for measuring a concentration of reprocessing agents in a reprocessing liquid used in the reprocessing apparatus 1 for medical instruments of FIG. 2 in more detail.

The arrangement 10 comprises a measuring system 100 connected to the reprocessing circuits 11, 12, such as to the circulation pump 13, via a first conduit 120 hydraulic connection of the measuring system. Furthermore, the measuring system 100 is connected to the reprocessing chamber 18 via a second conduit 130 for a bypass connection. The first and second conduits can form a bypass circuit for reprocessing liquid to be fed through measuring system 100. The measuring system 100 may be further connected to a compressed air supply 204.

During operation of the apparatus 1, one or several medical instruments 20 are placed into the loading carrier 21 and connected via the adapter plate 22 and the loading carrier coupling 23 to the inner reprocessing circuit 12 for rinsing the inner channel(s) of the medical instrument(s) 20 with reprocessing fluid.

The reprocessing chamber 18 may be filled with reprocessing liquid containing a reprocessing agent using spray arms 19 via the outer reprocessing circuit 11. The reprocessing chamber 18 may hold the reprocessing liquid for a predetermined amount of time. Alternatively and/or additionally, the circulation pump 13 may be used to re-circulate the reprocessing liquid containing the reprocessing agent by pumping it via the circulation pump 13 from the pump sump 14 to the spray arms 19 in the outer reprocessing circuit 11 and/or to the inner channel(s) of the medical instrument(s) 20 in the inner reprocessing circuit 12 for a pre-determined amount of time and/or number of cycles.

During cycling, reprocessing liquid may be taken, continuously or repeatedly, from the outer reprocessing circuit 11 via the first conduit 120 to supply it to the measuring system 100, in which the concentration of the reprocessing agent in the reprocessing liquid is measured.

Dosing unit 24 may supply additional reprocessing agent according to the measurements of measuring system 100. After measuring the concentration of the reprocessing agent, the remaining reprocessing liquid may be fed back to the outer reprocessing circuit 11 via the second conduit 130. The dosing unit is configured to dispense controlled quantities of components of the rinsing liquid used for reprocessing (e.g., cleaner, disinfectant, activator) in order to ensure a mixing ratio appropriate for the application, taking into account the relevant boundary conditions (e.g., quantity of water provided, reprocessing program used, tolerance of the measuring technology and conveyor technology, tolerance of the production fluctuation in the manufacture of the chemicals, etc.)-depending on the measured values determined by the measuring system.

At the end of a reprocessing procedure, such as after a pre-determined amount of time and/or number of recirculation cycles with a required concentration of reprocessing agents in the reprocessing liquid, the reprocessing chamber 18 may be emptied via the structural drain 17 by using the drain pump 15 for pumping the time liquid through the check valve 16 into the structural drain 17.

The measuring system 100 may be located outside of a housing of the apparatus 1 or may have an interface on an outer periphery of the apparatus 1.

The measuring system 100 is configured to receive a test strip 700 with a test surface 702 and to position the test strip 700 in a first, dosing position A and a second, measuring position B, both located along a test strip guide 570, as can be seen in FIG. 3. The measuring system 100 is further configured to dose a predetermined amount of reprocessing liquid onto the test surface 702 when the test strip 700 is positioned in the first, dosing position A via a reprocessing liquid feed system and a sample feed line 101 connected thereto.

The measuring system 100 can comprise an evaluating unit (evaluating sensor) 102 for measuring the concentration of reprocessing agents in the reprocessing liquid when the test strip 700 is positioned in the second, measuring position B by evaluating the test surface 702. The evaluating unit 102 may comprise an optical spectrometer and/or an RGB color sensor, and the evaluating unit 102 may be configured to compare the evaluation result with a reference value. For example a characteristic, such as a color characteristic, of the test surface 702 may be determined, and compared with a reference characteristic. The predetermined amount of reprocessing liquid may act on the test surface 702 for a predetermined exposure time before evaluating the test surface 702. After evaluating the test surface 702, the test strip 700 is released.

The arrangement 10 for measuring a concentration of reprocessing agents in a reprocessing liquid used in a reprocessing apparatus 1 for medical instruments 20 can further comprise a transport arrangement 300 for transporting a test strip 700. The transport arrangement 300 may be used for transporting a test strip 700. A single test strip 700 can be transported.

The arrangement 10 for measuring a concentration of reprocessing agents in a reprocessing liquid used in a reprocessing apparatus 1 for medical instruments 20 can further comprise a reprocessing liquid feed system 200 for dosing a predetermined amount of reprocessing liquid onto a test surface 702 of a test strip 700.

A method 3000 for measuring a concentration of reprocessing agents in a reprocessing liquid used in a reprocessing apparatus 1 for medical instruments 20 may comprise the following steps: In a first step 3001, a test strip 700 with a test surface 702 is positioned in a first, dosing position A. In step 3002, a predetermined amount of reprocessing liquid is dosed onto the test surface 702. In step 3003, the test strip 700 is positioned in the second, measuring position B and in step 3004 the test surface 702 is evaluated to measure the concentration of reprocessing agents in the reprocessing liquid, in substep 3004a by using an evaluating unit 102, such as an optical spectrometer and/or an RGB color sensor; and/or in substep 3004b by determining a characteristic, such as a color characteristic, of the test surface 702.

The step of dosing 3002 may comprise the step of 3002a for providing a hydraulic connection of the measuring system 100 with a reprocessing circuit 11, 12 of the reprocessing apparatus 1, such as with the circulation pump 13 of the reprocessing apparatus 1, such as via a first conduit 120; and/or the step 3002b of providing a bypass connection of the measuring system 100 back into a reprocessing chamber 18 of the reprocessing apparatus 1, via a second conduit 130.

Further during the step of dosing 3002, in substep 3002c the predetermined amount of reprocessing liquid can act on the test surface 702 for a predetermined exposure time before evaluating the test surface 702. Finally, after evaluating the test surface 702, the test strip 700 is released in step 3005.

The method 3000 for measuring a concentration of reprocessing agents in a reprocessing liquid used in a reprocessing apparatus 1 for medical instruments 20 can be part of a method 3100 for reprocessing medical instruments 20, comprising step 3101 of providing at least one medical instrument 20 in a reprocessing chamber 18 and the step 3102 of circulating reprocessing fluid in a reprocessing circuit 11, 12.

One, several or all steps and/or substeps of method 3000 may be repeated once, twice or several times, for example continuously, intermittently or at certain intervals, in order to monitor the concentration of reprocessing agents in a reprocessing liquid used in a reprocessing apparatus 1 for medical instruments 20 during a reprocessing cycle. The measurement results can be stored and/or used for a documentation of the reprocessing of the medical instrument(s).

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. An apparatus for measuring a concentration of reprocessing agents in a reprocessing liquid used in a reprocessing apparatus for medical instruments, the apparatus comprising
a measuring system;
a first conduit for a hydraulic connection of the measuring system with a reprocessing circuit of the reprocessing apparatus;
and a second conduit for a bypass connection of the measuring system into a reprocessing chamber of the reprocessing apparatus;
wherein the measuring system is configured to:
receive a test strip with a test surface and to position the test strip in a first, dosing position and a second, measuring position;
dose a predetermined amount of reprocessing liquid onto the test surface when the test strip is positioned in the first, dosing position; and
measure the concentration of reprocessing agents in the reprocessing liquid when the test strip is positioned in the second, measuring position by evaluating the test surface, via an evaluating sensor.

2. The apparatus according to claim 1, wherein the reprocessing circuit comprises a circulation pump of the reprocessing apparatus.

3. The apparatus according to claim 1, wherein one or more of:
the evaluating sensor comprises one or more of an optical spectrometer and an RGB color sensor; and
the evaluating sensor is configured to compare an evaluation result with a reference value.

4. The apparatus according to claim 1, wherein the measuring system is configured to measure the concentration of reprocessing agents in the reprocessing liquid when the test strip is positioned in the second, measuring position by determining a characteristic of the test surface.

5. The apparatus according to claim 4, wherein the characteristic is a color characteristic.

6. The apparatus according to claim 4, wherein the measuring system is configured to compare the determined characteristic with a reference characteristic.

7. The apparatus according to claim 1, wherein the measuring system is configured to let the predetermined amount of reprocessing liquid act on the test surface for a predetermined exposure time before the test surface is evaluated via the evaluating sensor.

8. The apparatus according to claim 7, wherein the predetermined exposure time is between at least 3 seconds and at least 30 seconds.

9. The apparatus according to claim 7, wherein the predetermined exposure time is between a maximum of 3 seconds and a maximum of 30 seconds.

10. The apparatus according to claim 1, further comprising a test strip guide, wherein the first, dosing position and the second, measuring position are located along the test strip guide.

11. The apparatus according to claim 1, wherein the measuring system is configured to release the test strip after evaluating the test surface via the evaluating sensor.

12. The apparatus according to claim 1, wherein the measuring system is configured to dose the predetermined amount of reprocessing liquid onto the test surface when the test strip is positioned in the first, dosing position via a reprocessing liquid feed system and a sample feed line connected thereto.

13. A reprocessing apparatus for medical instruments, the reprocessing apparatus comprising:
the apparatus for measuring a concentration of reprocessing agents in a reprocessing liquid according to claim 1;
the reprocessing chamber; and
the reprocessing circuit.

14. A method for measuring a concentration of reprocessing agents in a reprocessing liquid used in a reprocessing apparatus for medical instruments, the method comprising:
positioning a test strip with a test surface in a first, dosing position;
dosing a predetermined amount of reprocessing liquid onto the test surface when the test strip is positioned in the first, dosing position; and
positioning the test strip second, measuring position and evaluating the test surface to measure the concentration of reprocessing agents in the reprocessing liquid.

15. The method according to claim 13, further comprising one or more of:
measuring the concentration of reprocessing agents in the reprocessing liquid when the test strip is positioned in the second, measuring position by using an evaluating sensor; and
measuring the concentration of reprocessing agents in the reprocessing liquid when the test strip is positioned in the second, measuring position by determining a characteristic of the test surface.

16. The method according to claim 13, wherein the evaluating sensor is one or more of an optical spectrometer and an RGB color sensor.

17. The method according to claim 13, wherein the characteristic is a color characteristic.

18. The method according to claim 13, further comprising one or more of:
providing a hydraulic connection of the measuring system with a reprocessing circuit of the reprocessing apparatus; and
providing a bypass connection of the measuring system into a reprocessing chamber of the reprocessing apparatus.

19. The method according to claim 13, further comprising one or more of:
letting the predetermined amount of reprocessing liquid act on the test surface for a predetermined exposure time before evaluating the test surface; and
dosing the predetermined amount of reprocessing liquid onto the test surface when the test strip is positioned in the first, dosing position via a reprocessing liquid feed system and a sample feed line connected thereto.

20. The method according to claim 13, further comprising releasing the test strip after evaluating the test surface.

21. A method for reprocessing medical instruments, comprising:
providing at least one medical instrument in a reprocessing chamber and circulating reprocessing fluid in a reprocessing circuit, in a reprocessing apparatus for medical instrument; and
measuring a concentration of reprocessing agents in a reprocessing liquid used in a reprocessing apparatus for medical instruments according to claim 14.
